(19) United States
(12) Patent Application Publication
(10) Pub. No.: US 2009/0043881 A1
(43) Pub. Date: Feb. 12, 2009

(54) CACHE EXPIRY IN MULTIPLE-SERVER ENVIRONMENT

(75) Inventor: Kent Alstad, Sechelt (CA)

Correspondence Address: RAUBVOGEL LAW OFFICE, 820 LAKEVIEW WAY, REDWOOD CITY, CA, 94062, US

(73) Assignee: STRANGELOOP NETWORKS, INC., Vancouver (CA)

(21) Appl. No.: 11/837,388

(22) Filed: Aug. 10, 2007

(51) Int. Cl. G06F 15/173

(52) U.S. Cl. 709/224

(57) ABSTRACT

In a multiple-server or multiple-process environment where each server has a local cache, data in one cache may become obsolete because of changes to a data store performed by another server or entity. The present invention provides techniques for efficiently notifying servers as to cache expiry indications that indicate that their local cache data is out of date and should not be used. A cache expiry manager receives cache expiry indications from servers, and sends cache expiry indications to servers in conjunction with client requests or in response to certain trigger events. The need for broadcasting cache expiry notifications to all servers is eliminated, as servers can be informed of cache expiry indications the next time a server is being given a client request that relates to the cache in question. Extraneous and duplicative cache expiry notifications are reduced or eliminated.

### CROSS-REFERENCE TO RELATED APPLICATIONS

The present application contains subject matter that may be related to subject matter contained in co-pending U.S. patent application Ser. No. 11/359,637, filed on Feb. 21, 2006 and entitled “Storing and Retrieving User Context Data”, the disclosure of which is incorporated herein by reference.

The present application contains subject matter that may be related to subject matter contained in co-pending U.S. patent application Ser. No. 11/623,028 filed on Jan. 12, 2007 and entitled “ASYNCHRONOUS CONTEXT DATA MESSAGING,” (attorney docket number 12123) the disclosure of which is incorporated herein by reference.

### FIELD OF THE INVENTION

This invention relates generally to cache management, and more particularly to techniques for communicating cache expiry indications in a multiple-server environment.

### BACKGROUND OF THE INVENTION

In a client/server environment, servers usually have access to one or more data repositories (referred to herein as “data stores”) that store information that is used when responding to client requests. A data store can include a database, file system, memory repository, or any other storage device. When a client request is received, a server obtains information from one (or more) of the data stores, processes the obtained information, and transmits a response to the client. Where appropriate, the server may update the data store with new information received from the client. This new information might later be retrieved by the server or by another server in the course of processing another request.

The process of retrieving information from a data store can be slow, particularly when the data store is large, remotely located, or burdened with many requests concurrently. A known technique for addressing this problem is to use caches to reduce latency when accessing the data store and thereby improve performance of servers. A cache is an area of memory (or other storage mechanism) where data can be stored on a temporary basis for rapid access. For example, a cache associated with a server stores information and/or resources relevant to a user interaction or transaction handled by the server. The cache may be located at the server, or at some location that facilitates quick retrieval of data. The cache may be implemented in RAM or in magnetic or optical storage medium. Use of a cache allows future interactions that require access to such information and/or resources to be serviced more quickly, because the server need only consult its cache and does not need to retrieve information from the data store. When a server recognizes that a change has been made causing cache data to be obsolete or invalid, the cached data can be removed from the cache or can be tagged as having expired so that future requests are serviced by obtaining data from the data store rather than from the cache. For purposes of the description herein, the terms “invalid”, “obsolete”, and “out-of-date” are equivalent, referring to cache data that is no longer current.

In many client/server environments, multiple servers (such as web servers) are provided. Client requests may be distributed among servers according to various techniques referred to as “load balancing”. Load balancing takes into account traffic at various servers so that client requests can be directed to the servers most able to service the requests effectively. Accordingly, it is often the case that an initial client request will be serviced by one server, while a subsequent request might be serviced by a different server, due to changing load conditions, random or sequential allocation, or other factors.

When a subsequent client request that modifies the data is serviced by a server other than the server that serviced the initial request, any cache data stored by the first server may become obsolete. For example, a server A stores inventory information resulting from a user's initial interaction with a website; such information is stored in the data store and may also be stored in server A's cache. In a subsequent interaction serviced by server B, the inventory information would be retrieved from the data store (since server B would not normally have access to the server A's cache). Any changes to the inventory made during this subsequent interaction would not be reflected in the server A's cache; thus, the server A's cache would be invalid. If a third interaction were to be serviced by the first server, the first server might inadvertently use obsolete data from its cache, since it might not be aware that the data has been rendered obsolete by virtue of the interaction that took place at the second server.

Some prior art systems handle cache expiry by broadcasting notification to all servers when a cache expiry event takes place. Such an approach severely impacts network performance because it can overload the available bandwidth of the network. This phenomenon is referred to as network flooding.

What is needed, therefore, is a mechanism by which a cached item can be removed or properly tagged as having expired when it becomes obsolete, so that inadvertent use of the obsolete data can be avoided. What is further needed is a mechanism that manages such cache expiry in a multiple-server environment where each server does not have access to caches associated with other servers, without flooding the network and without causing significant deterioration in network performance. What is further needed is a mechanism for providing the advantages of cache use in a load-balanced multiple-server environment while still preserving data integrity.

### SUMMARY

According to the techniques of the present invention, servers transmit cache expiry indications to a module, referred to herein as a cache expiry manager, operatively disposed between a network and at least one server. The cache expiry manager may be implemented, for example, as part of or operatively connected to a load balancer. Client requests are inspected by the cache expiry manager before they are passed on to servers.

The cache expiry manager helps ensure that obsolete cache data is properly removed or tagged as having expired. As mentioned above, the cache expiry manager receives cache expiry indications from servers. In one embodiment, such indications are received from servers in connection with other data passing from the server to the cache expiry manager; in other embodiments, such indications are transmitted from servers to the cache expiry manager independently of other data.

An example of a cache expiry indication is a notification that a particular subset of the data in a data store has been updated; such a notification would indicate that any cached item should be tagged as having expired if it contains data that a) originated from the changed portion of the data store; and b) was copied from the data store before the update took place. In some embodiments of the invention, a portion of the cache can be designated as having expired without so designating the entire cache; the level of granularity at which cache data can be tagged as having expired can vary from implementation to implementation.

The cache expiry manager stores an indication that cache data has expired. Subsequently, responsive to a trigger event occurring with respect to a server, the cache expiry manager transmits a cache expiry indication to inform the recipient server that certain cache data the server may have is obsolete and should not be used. In this manner, a server can reliably be informed of a cache expiry event that has taken place at a different server. Bandwidth is reduced because multiple cache expiry indications can be stored at the cache expiry manager until a trigger event occurs, and then only one expiry indication need be sent, for example the most recent one.

In one embodiment, any of the following trigger events can cause a cache expiry indication to be sent:

A client request is being sent to a server. In this case, the cache expiry indication is sent along with the client request.

A timeout. If a cache expiry indication has not been sent to the server within a predetermined period of time (such as 100 milliseconds) after it was stored at the cache expiry manager, the cache expiry indication is sent to the server on its own (even if no client request is being sent).

Cache expiry indication maximum is met. If stored cache expiry indications accumulate at the cache expiry manager to the point where a maximum number of cache expiry indications have been stored, one or more cache expiry indications are sent to corresponding servers.

Storage space limitation is met. If stored cache expiry indications accumulate at the cache expiry manager to the point where a predetermined storage space limitation is met, one or more cache expiry indications are sent to corresponding servers.

The present invention provides a high level of efficiency in passing cache expiry indications. According to the present invention, cache expiry indications are not transmitted to all servers immediately upon receipt of the cache expiry indication at the cache expiry manager. Rather, each cache expiry indication is transmitted the next time a server is being given a client request that relates to the cached data in question, or upon occurrence of another trigger event. During periods of high traffic, cache expiry indications tend to be sent with client requests; at such times, the techniques of the present invention are particularly advantageous since they reduce bandwidth when the network is saturated. During lower-traffic periods, when client requests are less frequent, some or all cache expiry indications may be sent on their own, without client requests; at such times, there is less need for bandwidth reduction, and cache expiry indications need not be delayed until the next client request. The present invention is thus able to adapt to changing network traffic conditions, so as to provide improved efficiency while maintaining timeliness of cache expiry reporting.

Thus, the present invention reduces the amount of bandwidth and processing power needed to handle cache expiry notifications, and minimizes or eliminates network flooding that can occur when large numbers of expiry notifications are broadcast to all servers substantially simultaneously. Furthermore, if a server does not receive any requests for some period of time, multiple cache expiry indications for that server can be queued at the cache expiry manager until a client request comes in for that server or until some other trigger event has occurred. In this manner, the number of redundant or duplicative cache expiry indications is reduced or eliminated.

When a server receives a cache expiry indication from the cache expiry manager, it purges the indicated cached items (or otherwise records that the data has expired and should not be used). If data is needed to process the client request, the server does not use the cache, but instead obtains the data from the data store or from another server that has updated data. In this manner, the present invention ensures that a server will not use obsolete cache data, even if the event that caused the data to become outdated took place at a different server.

The present invention thus provides an efficient mechanism for transmitting cache expiry indications from one server to another to ensure that expired cache data will not be used. The expiry indications are transmitted via the cache expiry manager and are only sent to servers when a client request is sent or when some other trigger event has occurred, so as to limit the amount of bandwidth and processing power consumed in communicating cache status among servers.

### BRIEF DESCRIPTION OF THE DRAWINGS

FIG. 1 is a block diagram depicting an architecture for practicing the present invention according to one embodiment.

FIG. 2A is an event diagram depicting processing of a client request, where data is obtained from a data store to service the request.

FIG. 2B is an event diagram depicting processing of a client request, where data is obtained from a local cache to service the request.

FIG. 2C is an event diagram depicting processing of a client request, where a first server causes a change to data store data resulting in a cache expiry event.

FIG. 2D is an event diagram depicting processing of a client request, where a cache expiry indication is communicated to a second server.

FIG. 2E is an event diagram depicting generation and transmission of a cache expiry indication without a client request, in response to a trigger event.

FIG. 3 is a block diagram depicting a server for use in connection with an embodiment of the present invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

In the following description of embodiments of the present invention, numerous specific details are set forth in order to provide a more thorough understanding of the present invention. However, it will be apparent to one skilled in the art that the present invention may be practiced without one or more of these specific details. In other instances, well-known features have not been described in detail to avoid unnecessarily complicating the description.

For illustrative purposes, the present invention is described herein in the context of a system including multiple servers that service client requests received from user computers. However, one skilled in the art will recognize that the invention can be implemented in other contexts as well, and in connection with other types of components than those described herein. For example, in some embodiments, the techniques of the present invention can be used for cache management where more than one process is provided, and wherein each process manages its own cache. Thus, for example, in a parallel computing application where the activities of one process can cause invalidation of a cache associated with another process, the present invention provides mechanisms for informing the appropriate process(es) of cache expiry without flooding the entire system with broadcast cache expiry messages. The description set forth herein, which describes the invention in terms of servers operating in a wide area network, is therefore intended to be illustrative but not limiting of the scope of the present invention. In particular, although the term “server” is used repeatedly herein, modules (or processes or components) other than servers can be used. Additionally, the present invention can be used in systems including multiple virtual servers or multiple processes.

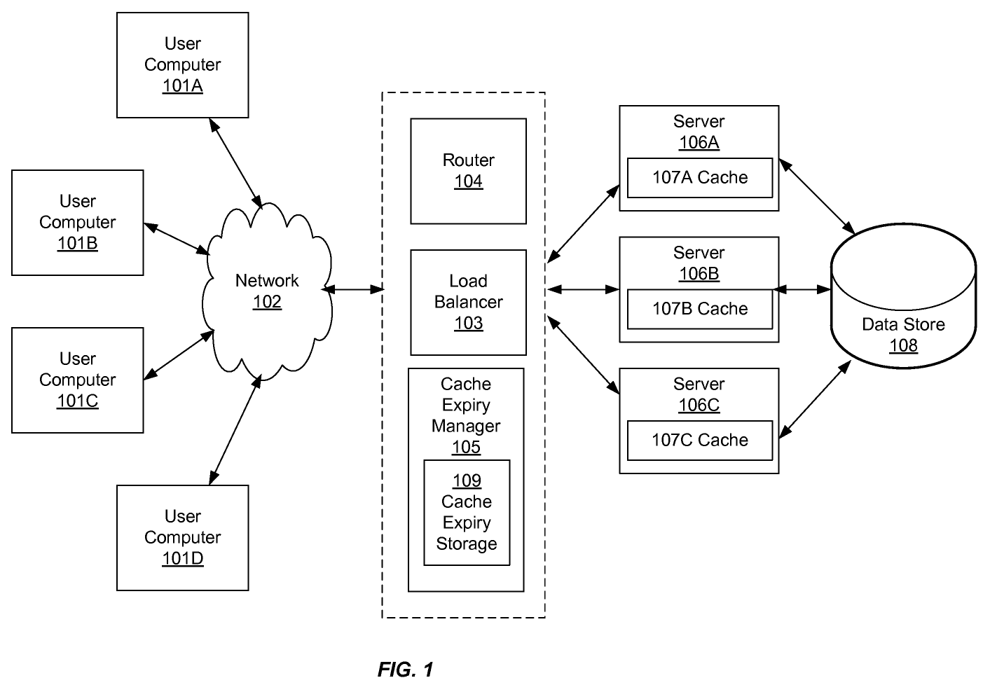

Referring now to FIG. 1, there is shown a block diagram depicting an example of an architecture for practicing the present invention. User computers 101A-101D are connected to network 102. In one or more embodiments, network 102 is a wide area network (WAN) (such as the Internet, which is commonly referred to as the “web”). User computers 101A-101D can access the web via any standard web browser (e.g., Internet Explorer® by Microsoft Corporation) or access server resources via any client application. Further, it is noted that network 102 is not limited to the Internet per se and may be instead or additionally associated with one or more other types of network (e.g., a virtual private network (VPN), an enterprise network, an intranet, a local area network (LAN), or an extranet).

User computers 101A-101D may be connected to network 102 through at least one of several connection modules and/or devices, including routers, modems, firewalls, security devices, and wireless access points. These connection modules and/or devices are not shown as such connection modules, devices and methods are well known in the art. In one embodiment, user computers 101A-101D communicate with the functional components of the present invention using well-known network protocols such as TCP/IP and HTTP.

The term “user computer”, as used herein, refers to any electronic module (e.g., a physical device, a software instance) capable of sending to and receiving messages from a network. A non-exhaustive list of examples of user computers includes personal desktop computers, laptop/notebook computers, enterprise computing systems, mobile phones, handheld computing devices, personal digital assistants (PDAs), gaming consoles, voice-over-IP (VoIP) telephone systems, and portable entertainment systems. One skilled in the art will recognize that any number of devices, modules, and/or systems may be implemented to fulfill the role of the “user computer” described herein without departing from the scope of the present invention.

Further, it is noted that data may be communicated according to one or more of various protocols. For example, in an application layer, data may be communicated according to any one or more of the following protocols: DHCP; DNS; FTP; HTTP; IMAP4; IRC; MIME; POP3; SIP; SMTP; SNMP; SSH; TELNET; TLS/SSL; RPC; RTP; SDP; and SOAP. In a transport layer, data may be communicated according to any one or more of the following protocols: TCP; UDP; RSVP; DCCP; and SCTP. In a network layer, data may be communicated according to any one or more of the following protocols: IP; ARP; BGP; ICMP; IGMP; IGP; and RARP. In a data link layer, data may be communicated according to one or more of the following mechanisms: ATM; Bluetooth; Ethernet; FDDI; Frame Relay; GPRS; modems; PPP; and Wi-Fi. In a physical layer, data may be communicated using any or more of the following: Bluetooth RF; Ethernet physical layer; ISDN modems; RS-232; SONET/SDH; USB; and Wi-Fi.

Via connection to network 102, user computers 101A-101D can access a website (or websites) hosted by one or more of servers 106A-106C. Servers 106A-106C are physical devices and/or software instances capable of receiving a request for data and transmitting data in response, such as for example web servers. For example, one or more of servers 106A-106C may be an HTTP server capable of receiving page requests and returning web pages. As another example, one or more of servers 106A-106C may be capable of sending datagrams according to a protocol (e.g., User Datagram Protocol (UDP), Transmission Control Protocol (TCP)). Any number of servers 106A-106C can be provided for servicing client requests received from user computers 101A-101D. Moreover, one or more of servers 106A-106C may consist of multiple physical devices or software instances, which in conjunction have the capabilities of a single server or several servers. In other embodiments, the present invention can be implemented in a virtualized system where multiple servers or virtual computers exist in a single physical architecture. One skilled in the art will recognize that many other architectures are possible, and that the present invention can be implemented in connection with such architectures without departing from the essential characteristics.

Further, one or more of servers 106A-106C may be implemented using at least one of the many modules and/or devices commonly available for responding to data requests. For example, one or more of servers 106A-106C may be implemented using a standard personal computer (PC) and software such as Apache HTTP Server. One or more of servers 106A-106C may also be implemented, for example, using Microsoft® Internet Information Services, ASP.NET 2.0, ASP.NET 1.1, Classic ASP, JSP, IBM® Websphere, Ruby on Rails, or Linux Apache PHP. Moreover, one or more of servers 106A-106C may be implemented as online gaming servers. Those skilled in the art will recognize that these examples are not intended to be exhaustive and that other implementations of servers may be used in one or more embodiments.

Load balancer 103 may be implemented to balance client requests across servers 106A-106C. Load balancer 103 is capable of receiving an incoming client request and redirecting it to a particular one of servers 106A-106C based on one or more load balancing method and settings in load balancer 103 (for example on the basis of availability or workload of various servers 106A-106C). For example, if server 106A is overloaded due to a high volume of requests, but server 106C has available request-handling capability, the load balancer 106A directs incoming client requests to server 106C. Load balancer 103 may be implemented using any one of many commonly available load balancing methods. Such methods may involve, for example, random allocation, round-robin allocation, weighted round-robin, least connections, and IP hashing.

Router 104 is capable of receiving an incoming client request and repeating it on at least one of a plurality of network ports. Router 104 may also modify the incoming client request before repeating it, such as in the known method of network address translation (NAT).

Load balancer 103 and router 104 may be disposed in series or in connection with a cache expiry manager 105. As described in related co-pending U.S. patent application Ser. No. 11/623,028 referenced above, in one embodiment an acceleration engine (not shown) stores, retrieves, and updates context data. In one embodiment, cache expiry manager 105 is the same module and/or device as the acceleration engine. In another embodiment, these functions are performed by different devices. Alternatively, the cache expiry techniques described herein can be performed without an acceleration engine or other context data processing components.

For purposes of the following description, cache expiry manager 105 is operatively disposed between network 102 (or a network access point, not shown) and the plurality of servers 106A-106C. In such a manner, cache expiry manager 105 may intercept messages between user computers 101A-101D and servers 106A-106C. By “intercept”, it is meant that cache expiry manager 105 inspects or somehow reads data from the incoming request.

The connection of cache expiry manager 105 with router 104 and/or acceleration engine (if provided) may vary. In one or more embodiments, cache expiry manager 105 may operate using the same physical hardware (such as processor, network ports, electronic storage) as router 104 and/or acceleration engine (if provided). In one or more other embodiments, cache expiry manager 105 may share physical hardware with other components. In yet other embodiments, cache expiry manager 105 may share some physical hardware (such as enclosure, power supply, and network ports) but not certain other physical hardware (such as processor and electronic storage). In yet other embodiments, cache expiry manager 105 may not share any physical hardware with the router 104 and/or acceleration engine (if provided), but still may be connected in series to at least one such module and/or device.

In one or more embodiments with multiple routers 104, cache expiry manager 105 may be joined to any one of the routers 104 so long as the placement operatively disposes cache expiry manager 105 in the data path between servers 106A-106C and network 102. According to one or more embodiments, multiple cache expiry managers 105 may be implemented and connected either in series or parallel in the data path between a server and a network. In one or more embodiments, when multiple routers 104 are implemented hierarchically, the cache expiry manager 105 may be adjoined to router 104 with the highest position in the hierarchy of those routers 104 connected to servers 106A-106C.

As described above, cache expiry manager 105 may be adjoined to router 104 and/or acceleration engine (if provided) in various ways. In one or more embodiments, cache expiry manager 105 may not share any physical hardware with these components. In such a case, load balancer 103, router 104, acceleration engine (if provided), and cache expiry manager 105 may be connected in series and may be connected in any order.

Load balancer 103, router 104, acceleration engine (if provided), cache expiry manager 105, and servers 106A-106C may be part of a local area network (LAN). For example, these components may be located within and administered by a particular organization (e.g., a company, government entity). However, it is entirely possible that one or more of these components may be remotely located from another component. In such cases, remotely located components may be connected over a wide area network as opposed to by a local area network.

Data store 108 stores data to be used for servicing client requests. Data store 108 can be a conventional database or any other type of data repository. Some types of user interaction with a website hosted by one or more of servers 106A-106C may result in a need to retrieve information from data store 108 in order to service the client requests. Other types of user interactions may result in new data and/or changes to existing data stored in data store 108. For example, a user purchase of an item may cause a database record to be updated to indicate a change in the quantity on hand of the item. As another example, a user may update his or her online profile, so that a database record is changed to reflect the new profile data. Accordingly, in FIG. 1, data store 108 is indicated with communication pathways to and from servers 106A-106C.

Retrieval of information from data store 108 may take time, thus introducing added latency and reducing performance. In order to alleviate this problem, each server 106A-106C has a local cache 107A-107C where data from data store 108 can be cached for future access. Thus, instead of retrieving data from data store 108, a server 106A-106C can first consult its local cache 107A-107C. If the cache 107A-107C contains the needed data to service the client request, and if the data is valid (i.e., the cache 107A-107C is current and has not expired), then server 106A-106C need not request the information from data store 108 but can instead service the request using the locally cached data, thus reducing latency and improving performance.

As described above, the present invention provides a technique for efficiently informing one server 106A-106C that its cache data is out of date because of another server's changes to data in data store 108. The technique operates as follows.

When a server 106A-106C changes data in data store 108, it informs cache expiry manager 105 that such a change has been made. Cache expiry manager 105 stores a record in cache expiry storage 109. The record specifies the nature of the change and a time stamp indicating when the change took place. In one embodiment, the record also identifies the particular server 106A-106C that made the change to the data store 108 data. The level of granularity at which the nature of the change is specified can vary from one implementation to another; in one embodiment, the nature of the change can be specified at a very general level (e.g., which file in the data store was changed), whereas in other embodiments more details may be provided (e.g., the specific row and/or column of a database table that was changed).

Subsequently, when a new client request is being directed to a serv 106A-106C other than the one that generated the cache expiry, cache expiry manager 105 sends a cache expiry indication to that server 106A-106C along with the client request. The cache expiry indication can be transmitted either embedded within the client request, or it can be sent as part of an out-of-band transmission such as the context data path described in the above-referenced patent application for ASYNCHRONOUS CONTEXT DATA MESSAGING.

In one embodiment, cache expiry manager 105 transmits a cache expiry indication to one or more servers 106A-106C only if a) it is sending other data; and b) it is determined that the particular server(s) has a need for the data associated with the cache expiry indication. In another embodiment, cache expiry manager 105 does not make any such determination, but rather sends a cache expiry indication to one or more servers 106A-106C the next time it is sending other data to the same one or more servers 106A-106C.

Cache expiry manager 105 also updates its own local cache expiry storage 109 to reflect the fact that the server has been notified of the cache expiry. In general, whenever a client request is being sent to a server 106A-106C, cache expiry manager 105 checks its local cache expiry storage 109 to determine whether there are any cache expiry indications that the target server 106A-106C has not yet received. If so, it includes the appropriate indication in its transmission of the client request to the target server 106A-106C.

In one embodiment, the system of the present invention is able to detect changes made in data store 108 by entities other than a server 106A-106C. For example, a component can be included that periodically or continuously monitors the contents of data store 108. This component can be embedded within one of servers 106A-C, or it can be located at a separate server (not shown) or at any other location. When a change to data store 108 is detected, cache expiry manager 105 stores a record in cache expiry storage 109 in the same manner as it would if the change had been made by one of servers 106A-C.

In one embodiment, cache expiry storage 109 at cache expiry manager 105 includes records containing at least a subset of the following information for each cache expiry indication:

a unique identifier for the cache expiry indication;

date and time the event occurred (also known as a time stamp);

identifier of a server or other source of cache expiry indication;

a list of servers that have been sent the expiry indication (if any); and

a list of servers that have not yet been sent the expiry indication.

In one embodiment, cache expiry indications contain the same information that is stored in cache expiry storage 109, or some subset thereof.

In one embodiment, if more than one cache expiry indication refers to the same cache data, the multiple indications are reduced to a single expiry indication. This can be accomplished by merging multiple records at cache expiry storage 109. Alternatively, the multiple records can be retained, but expiry indications sent to servers 106A-106C are consolidated so as to remove redundancies.

In one embodiment, once all servers 106A-106C have been notified of a cache expiry (other than the server that originated it), cache expiry manager 105 deletes the expiry data from its cache expiry storage 109. In other embodiments, the cache expiry data is retained for logging, error-checking, or archival purposes.

When a server 106A-106C receives a cache expiry indication, it removes the affected data from its cache 107A-C or tags the data as expired and does not use the expired data. Instead, it retrieves updated data either from data store 108 or from one of servers 106A-106C that already has a copy of updated data, such as, for example, the server 106A-106C that caused the cache expiry by updating data store 108. In one embodiment, a determination is made as to whether it is more efficient to obtain the needed data from data store 108 or from a server 106A-106C, and the server 106A-106C that needs the data proceeds according to this determination. If the expiry event originated at one of servers 106A-106C, an indication as to which server 106A-106C contains fresh data can be found within the cache expiry event indication in one embodiment.

In one embodiment, notification of a cache expiry causes the server 106A-106C to expire or delete its entire cache 107A-C; in another embodiment, a subset of the cache 107A-C can be designated as out-of-date, based on the nature of the data store update that triggered the cache expiry event. Accordingly, it is possible that other cache data is still valid and can still be used.

In one embodiment, the present invention avoids unnecessary cache expiry notifications by only transmitting cache expiry notifications in conjunction with client requests. Thus, it is possible that some servers 106A-106C may not immediately be notified of a cache expiry; however, they will be notified at the appropriate time when they are called upon to respond to a client request.

In one embodiment, cache expiry indications are sent in response to certain trigger events, regardless of whether or not new client requests are being sent. For example, any of the following trigger events can cause a cache expiry indication to be sent:

A client request is being sent to a server. In this case, the cache expiry indication is sent along with the client request, as described above.

A timeout. If a cache expiry indication has not been sent to the server within a predetermined period of time (such as 100 milliseconds) after it was stored at the cache expiry manager, the cache expiry indication is sent to the server on its own (even if no client request is being sent).

Storage space limitation is met. If stored cache expiry indications accumulate at the cache expiry manager to the point where a predetermined storage space limitation is met, one or more cache expiry indications are sent to corresponding servers.

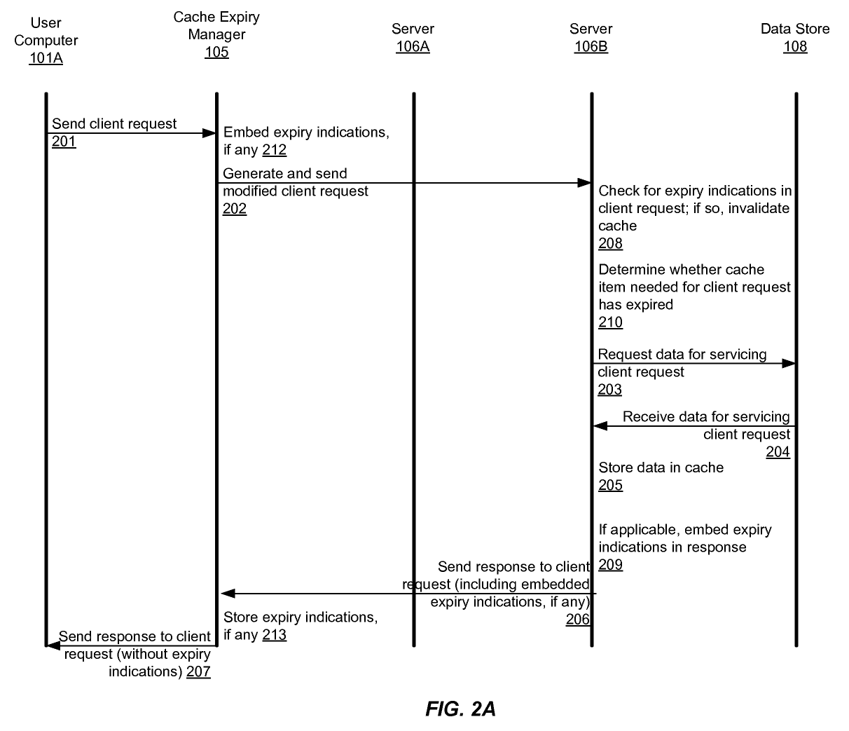

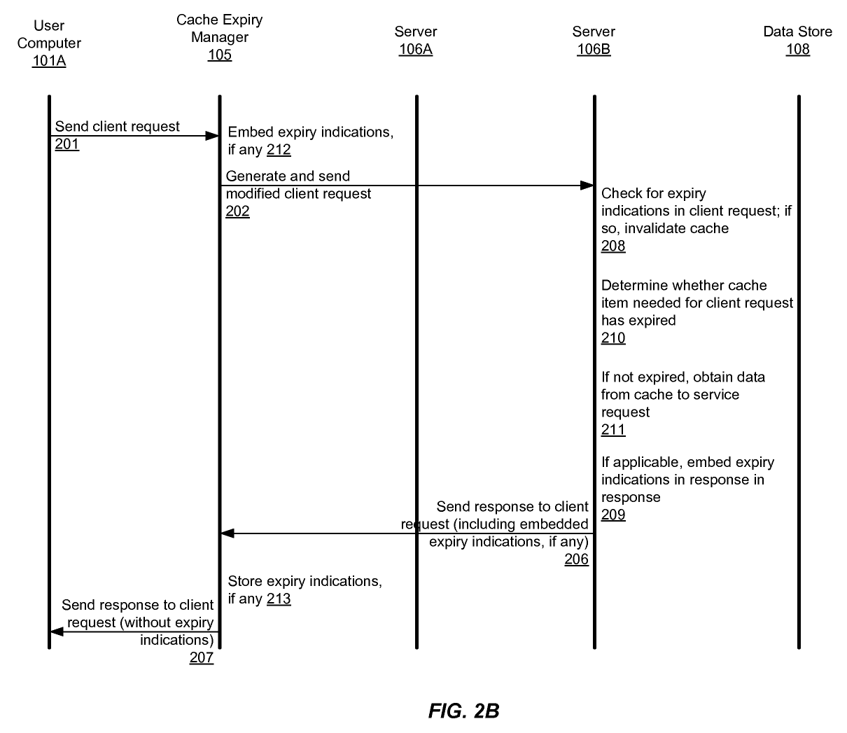

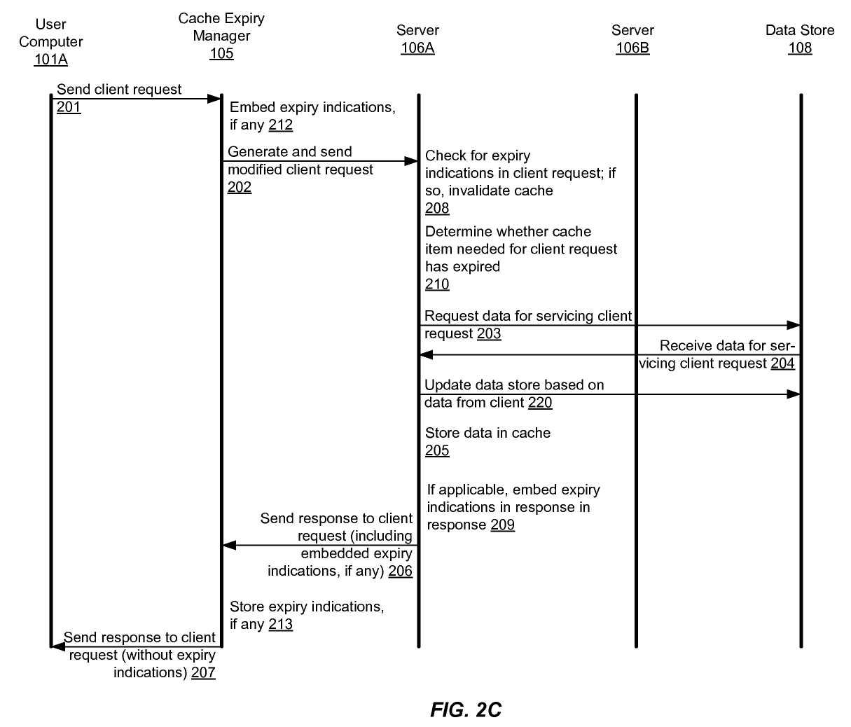

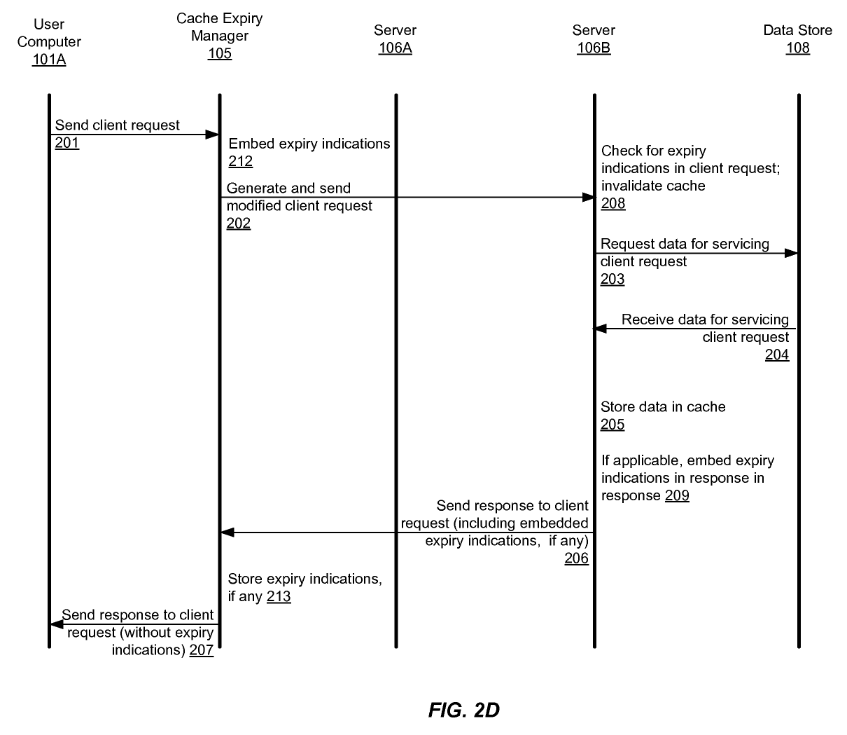

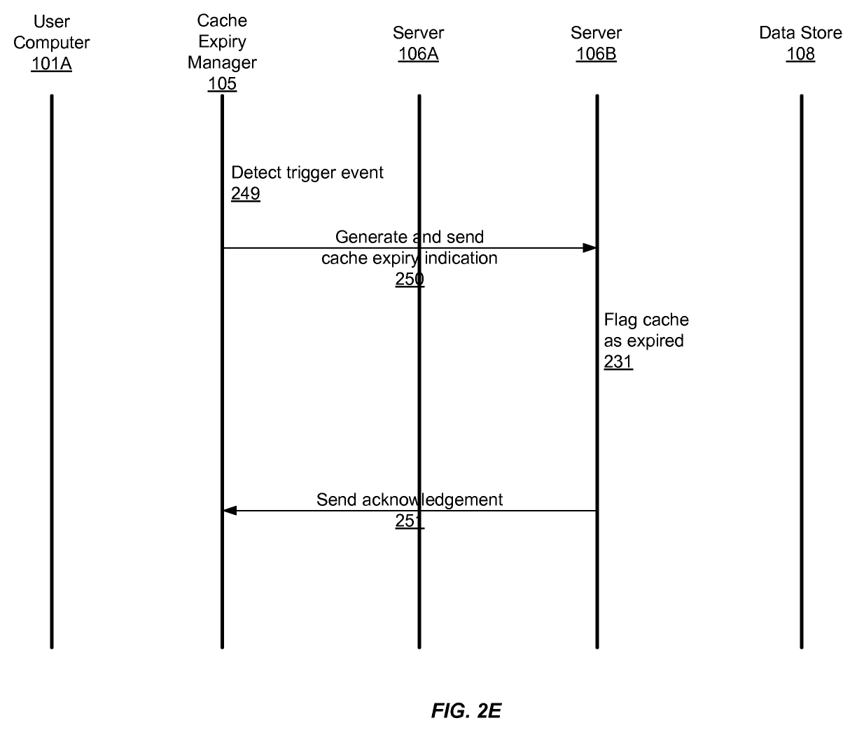

FIGS. 2A through 2E are event diagrams that illustrate examples of the operation of the present invention according to one embodiment.

Referring now to FIG. 2E, there is shown an example of an event diagram depicting generation and transmission of a cache expiry indication without a client request, in response to a trigger event. Cache expiry manager 105 detects 249 a trigger event. Trigger events can include, for example, a timeout or a storage space limitation being met, as described above. In some cases, a trigger event can include a determination that it is necessary, for any reason, to immediately inform one or more servers 106A-106C of a cache expiry indication. One skilled in the art will recognize that other trigger events can also be used. In response to the trigger event, cache expiry manager 105 generates and sends 250 a cache expiry indication to at least one server 106 (in the example of FIG. 2E, the cache expiry indication is sent to server 106B). In one embodiment, a null request can be generated and sent to the appropriate server 106; the cache expiry indication can be attached to the null request in the same way that it would be attached to an actual client request.

When the trigger event is detected, cache expiry indications can be sent to all servers 106 that have data, or to one server 106 for which the trigger event is detected, or to some subset of all servers 106. If two or more servers 106 are being notified, the indications can be sent simultaneously or sequentially. One skilled in the art will recognize that any methodology can be used for determining which servers 106 should receive the cache expiry indication and in what sequence.

Server 106B (and/or any other servers 106 that receive cache expiry indications) flags 231 its cache 107B as having expired. In one embodiment, it deletes cache 107B; in another embodiment it tags the data as expired, retains the data, but does not use the data in cache 107B. Server 106B (and/or any other servers 106 that receive cache expiry indications) sends 251 an acknowledgment indicating that the cache expiry indication was received.

The time stamp allows cache expiry manager 105 to determine how much time has elapsed since a cache expiry indication was generated, so that trigger events can be detected at appropriate times. In one embodiment, the time stamp also helps cache expiry manager 105 manage cache expiry data. For example, if two cache expiry indications are received for the same data, only the later one need be sent to servers 106A-106C. Also, in one embodiment, the time stamp is sent to server 106A-106C along with the cache expiry indication so that server 106A-106C can determine whether its cache data was retrieved prior to or after the cache expiry indication was generated. If its cache data is newer than the latest cache expiry indication, the cache data need not be tagged as out-of-date since it is still current. Thus, in one embodiment, server 106A-106C can make the determination, based on the cache expiry time stamp, as to whether or not its cache data should be tagged as out-of-date.

Referring now to FIG. 2A, there is shown an event diagram depicting processing of a client request, where data is obtained from data store 108 to service the request. This example assumes that no cache data is available or that the cache data is out of date.

User computer 101A generates and sends 201 client request via network 102. The client request may be for a web page, for example. The client request is intercepted by cache expiry manager 105 so that any additional data can be added as appropriate, for example by embedding 212 expiry indications. A modified client request is thus generated, including the additional data (in one embodiment, this additional data can include cache expiry indications and/or context data as described in the above-referenced co-pending patent application). Load balancer 103 determines which server 106A-106C is best able to handle the client request; in this case, the modified client request is sent 202 to server 106B.

Server 106B checks 208 the received client request for any cache expiry indications; if any expiry indications are found, it invalidates its cached item in cache 107B for example by tagging it as expired. Server 106B then determines 210 whether a cache item needed to service the client request has expired. Upon determining that no cache data is available or that its cache data has expired, server 106B requests data 203 from data store 108 in order to service the client request. It receives 204 the requested data, and stores the data 205 in its cache 107B. In one embodiment, a timestamp is stored as well, for comparison with cache expiry timestamps.

If any cache expiry indications need to be communicated to other servers 106, server 106B embeds 209 these expiry indications in its response to the client request. Server 106B then sends 206 its response to the client request, including any embedded expiry indications. In one embodiment, the response is transmitted directly to user computer 101A. In another embodiment, it passes through cache expiry manager 105 and/or other components such as an acceleration engine (not shown), which relay the response to user computer 101A. In one embodiment, cache expiry manager 105 stores 213 any expiry indications found in the response, and sends 207 the response to the user computer 101A without the expiry data. In one embodiment, user computer 101A formats the response accordingly and displays the information to the user; in other embodiments, the response may be handled in other ways.

Referring now also to FIG. 2B, there is shown an event diagram depicting processing of a client request, where data is obtained from a local cache to service the request. This example assumes that cache data was previously stored in cache 107B of server 106B.

User computer 101A generates and sends 201 client request via network 102. For illustrative purposes, FIG. 2B depicts the same user computer 101A as was shown in FIG. 2A as the originator of this client request; however, the originator can be a different user computer such as 101B, 101C, or 101D. The client request is intercepted by cache expiry manager 105 so that any additional data can be added as appropriate, for example by embedding 212 expiry indications. As before, a modified client request is thus generated, including the additional data such as cache expiry indications and/or context data as described in the above-referenced co-pending patent application. Load balancer 103 determines which server 106A-106C is best able to handle the client request; in this case, the modified client request is sent 202 to server 106B.

Server 106B checks 208 the received client request for any cache expiry indications; if any expiry indications are found, it invalidates its cache for example by tagging it as expired. Server 106B then determines 210 whether a cache item needed to service the client request has expired.

If the cache data has not expired, server 106B obtains 211 the cache data from cache 107B so that it can service the client request without retrieving information from data store 108. If any cache expiry indications need to be communicated to other servers 106, server 106B embeds 209 these expiry indications in its response to the client request. Server 106B then sends 206 its response to the client request, including any embedded expiry indications. In one embodiment, the response is transmitted directly to user computer 101A. In another embodiment, it passes through cache expiry manager 105 and/or other components such as an acceleration engine (not shown), which relay the response to user computer 101A. In one embodiment, cache expiry manager 105 stores 213 any expiry indications found in the request, and sends 207 the response to the user computer 101A without the expiry data. In one embodiment, user computer 101A formats the response accordingly and displays the information to the user; in other embodiments, the response may be handled in other ways.

Referring now also to FIG. 2C, there is shown an event diagram depicting processing of a client request, where a first server causes a change to data store data resulting in a cache expiry event.

User computer 101A generates and sends 201 client request via network 102. For illustrative purposes, FIG. 2C depicts the same user computer 101A as was shown in FIGS. 2A and 2B as the originator of this client request; however, the originator can be a different user computer such as 101B, 101C, or 101D. The client request is intercepted by cache expiry manager 105 so that any additional data can be added as appropriate, for example by embedding 212 expiry indications. As before, a modified client request is thus generated, including the additional data such as cache expiry indications and/or context data as described in the above-referenced co-pending patent application. Load balancer 103 determines which server 106A-106C is best able to handle the client request; in this case, the modified client request is sent 202 to server 106A.

Server 106A checks 208 the received client request for any cache expiry indications; if any expiry indications are found, it invalidates its cache 107A for example by tagging it as expired. Server 106A then determines 210 whether a cache item needed to service the client request has expired. Upon determining that no cache data is available or that its cache data has expired, server 106A requests data 203 from data store 108 in order to service the client request. It receives 204 the requested data. Then, based on data in the client request, server 106A sends 220 an update command to data store 108, to cause data there to be updated. Server 106A also stores 205 new, updated data in its cache 107B; since this new data does not predate the cache expiry indication, it will be considered valid data unless a subsequent cache expiry indication is received. In one embodiment, a timestamp is stored as well, for comparison with cache expiry timestamps. If any cache expiry indications need to be communicated to other servers 106 (for example to indicate that data store 108 has been updated), server 106A embeds 209 these expiry indications in its response to the client request. Server 106B then sends 206 its response to the client request, including any embedded expiry indications. In one embodiment, the response is transmitted directly to user computer 101A. In another embodiment, it passes through cache expiry manager 105 and/or other components such as an acceleration engine (not shown), which relay the response to user computer 101A. In one embodiment, cache expiry manager 105 stores any expiry indications found in the response, so that other servers will be notified that their cache data has been rendered out-of-date because of the data store changes made by server 106A. Cache expiry manager 105 then sends 207 the response to user computer 101A without the expiry data. In one embodiment, user computer 101A formats the response accordingly and displays the information to the user; in other embodiments, the response may be handled in other ways.

Referring now to FIG. 2D, there is shown an event diagram depicting processing of a client request, where a cache expiry event (such as that previously generated by server 106A in FIG. 2C) is communicated to a second server 106B.

User computer 101A generates and sends 201 client request via network 102. FIG. 2D depicts the same user computer 101A as was shown in FIGS. 2A-2C as the originator of this client request; however, the originator can be a different user computer such as 101B, 101C, or 101D. The client request is intercepted by cache expiry manager 105 so that any additional data can be added as appropriate, for example by embedding 212 expiry indications. As before, a modified client request is thus generated, including the additional data such as cache expiry indications and/or context data as described in the above-referenced co-pending patent application. In one embodiment, this additional data can also include cache context data as described in the above-referenced copending patent application. Load balancer 103 determines which server 106A-106C is best able to handle the client request; in this case, the modified client request is sent to server 106B.

Server 106B checks 208 the received client request for any cache expiry indications; if any expiry indications are found, it invalidates its cache 107B for example by tagging it as expired. In one embodiment, it deletes cache 107B; in another embodiment it tags the data as expired, retains the data, but does not use the data in cache 107B. Then, since no cache data is available, server 106B sends a new data request 203 to data store 108 in order to service the client request. It receives 204 the requested data, and stores the data 205 in its cache 107B. In one embodiment, a timestamp is stored as well, for comparison with cache expiry timestamps.

If any cache expiry indications need to be communicated to other servers 106, server 106B embeds 209 these expiry indications in its response to the client request. Server 106B then sends 206 its response to the client request. In one embodiment, the response is transmitted directly to user computer 101A. In another embodiment, it passes through cache expiry manager 105 and/or other components such as an acceleration engine (not shown), which relay the response to user computer 101A. In one embodiment, cache expiry manager 105 stores 213 any expiry indications found in the response, and sends 207 the response to the user computer 101A without the expiry data. In one embodiment, user computer 101A formats the response accordingly and displays the information to the user; in other embodiments, the response may be handled in other ways.

As mentioned above, in some cases cache expiry manager 105 may receive several cache expiry indications in succession, all referencing the same data in data store 108. In one embodiment, if this occurs, cache expiry manager 105 waits until it has a client request to forward to one of the servers 106A-106C, or until some other trigger event occurs, as discussed above; at such time, cache expiry manager 105 only sends the latest cache expiry indication. This saves bandwidth, since the entire stack of indications need not be sent.

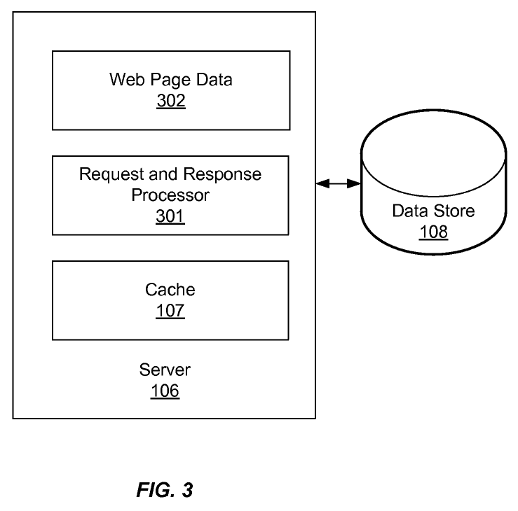

Referring now to FIG. 3, there is shown an example of a server 106 (such as server 106A, 106B, or 106C) for use in connection with an embodiment of the present invention. Server 106 includes request and response processor 301 that is responsible for processing an incoming client request and generating an appropriate response, such as for example a requested web page. A request and response processor may, for example, be IIS and ASP.NET, or one of many other available technologies. In processing the request and generating the response, server 106 may retrieve data from data store 108 and/or may retrieve data from its own cache 107 (which is representative of any cache 107A, 107B, or 107C shown in other Figs.) Further, server 106 may also access web page data 302 to generate its response (e.g., build/return a web page).

In one embodiment, the present invention operates as an enhancement to conventional cache management techniques. For example, in one embodiment, cache expiry indications are transmitted to individual servers 106A-106C when it is deemed beneficial to do so (for example, when overall network traffic is at a high level), but at other times cache expiry indications are broadcast to all servers 106A-106C (for example, when overall network traffic is below a predefined threshold level, or when it is critical that all servers 106A-106C be made known immediately of a cache expiry indication, or when it is determined that the changed data item is of sufficient importance). One mechanism for implementing such a scheme is to send cache expiry indications in response to trigger events, including timeout events or cache storage limit events.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference herein to “one embodiment”, “an embodiment”, or to “one or more embodiments” means that a particular feature, structure, or characteristic described in connection with the embodiments is included in at least one embodiment of the invention. Further, it is noted that instances of the phrase “in one embodiment” herein are not necessarily all referring to the same embodiment.

Some portions of the above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Further, the computers referred to herein may include a single processor or may be architectures employing multiple processor designs for increased computing capability.

The algorithms and displays presented herein are not inherently related to any particular computer, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. In a system including a plurality of processes interacting with a data store, a method for propagating a cache expiry indication signifying a change to an item in the data store, the method comprising:
receiving, from a first process, an indication that at least one item in the data store has been changed by the first process;
storing a cache expiry indication identifying the changed data item; and
responsive to receiving a subsequent request:
transmitting the stored cache expiry indication to a second process; and
transmitting the subsequent request to the second process.

2. The method of claim 1, wherein each process comprises a server and wherein the request comprises a client request.

3. The method of claim 2, further comprising, prior to transmitting the stored cache expiry indication and the subsequent request to the second server, selecting a server to receive the subsequent request.

4. The method of claim 3, wherein selecting a server to receive the subsequent request comprises performing a load-balancing operation to select the server.

5. The method of claim 2, wherein transmitting the subsequent request to a second server comprises transmitting the subsequent request to a second server having a cache comprising data at least partially derived from the data store.

6. The method of claim 2, wherein the stored cache expiry indication identifies at least one data item that has changed.

7. The method of claim 2, wherein the stored cache expiry indication specifies a date and time at which the source data store was changed.

8. The method of claim 2, wherein the stored cache expiry indication identifies the server that caused the change to the data item.

9. The method of claim 2, wherein the stored cache expiry indication identifies at least one server that has access to valid data in that server's cache.

10. The method of claim 2, further comprising:
receiving, at the second server, the cache expiry indication; and
tagging at least one cached item associated with the second server as having expired.

11. The method of claim 2, further comprising:
receiving, at the second server, the cache expiry indication; and
purging at least one cached item associated with the second server.

12. The method of claim 2, wherein transmitting the cache expiry indication to the second server comprises transmitting the cache expiry indication embedded within the subsequent request.

13. The method of claim 2, wherein transmitting the subsequent request and the cache expiry indication to the second server comprises:
modifying the subsequent request to include the cache expiry indication; and
transmitting the modified subsequent request to the second server.

14. The method of claim 2, wherein transmitting the cache expiry indication to the second server comprises transmitting the cache expiry indication using an out-of-band transmission channel.

15. The method of claim 2, wherein:
transmitting the subsequent request to the second server comprises transmitting the subsequent request using a first transmission channel; and
transmitting the cache expiry indication to the second server comprises transmitting the cache expiry indication using a second transmission channel.

16. The method of claim 2, wherein storing the cache expiry indication comprises:
determining whether the changed data item in the data store was referenced by a previously stored cache expiry indication; and
consolidating the cache expiry indication with the previously stored cache expiry indication.

17. The method of claim 2, wherein transmitting the stored cache expiry indication to the second server comprises transmitting a consolidated cache expiry indication that represents at least two cache expiry indications for the changed data item.

18. The method of claim 2, wherein:
transmitting the subsequent client request to a second server comprises using a load balancer to route the subsequent client request.

19. In a system including a plurality of processes interacting with a data store, a method for propagating a cache expiry indication signifying a change to an item in the data store, the method comprising:
monitoring the data store for changes;
detecting a change in the data store;
storing a cache expiry indication identifying the changed data item; and
responsive to receiving a subsequent request, transmitting the stored cache expiry indication.

20. In a system including a plurality of processes interacting with a data store, a method for propagating a cache expiry indication signifying a change to an item in the data store, the method comprising:
receiving, from a first process, an indication that at least one item in the data store has been changed by the first process;
storing a cache expiry indication identifying the changed data item; and
responsive to detecting a trigger event, transmitting the stored cache expiry indication to a second process;
wherein the trigger event comprises at least one selected from the group consisting of:
a subsequent request;
a determination that a predefined time period has elapsed since the cache expiry indication was stored;
a determination that a predefined number of cache expiry indications have been stored; and
a determination that a predefined amount of cache expiry indication storage has been used.

21. The method of claim 20, further comprising, responsive to the trigger event comprising a subsequent request, transmitting the subsequent request to the second process.

22. In a system including a plurality of processes interacting with a data store, a method for propagating a cache expiry indication signifying a change to an item in the data store, the method comprising:
receiving, from a first process, an indication that at least one item in a data store has been changed by the first process;
determining whether to broadcast a cache expiry indication identifying the changed data item;
responsive to a determination that a cache expiry indication should be broadcast, broadcasting a cache expiry indication identifying the changed data item;
responsive to a determination that a cache expiry indication should not be broadcast:
storing the cache expiry indication identifying the changed data item; and
responsive to receiving a subsequent request:
transmitting the cache expiry indication to the second process; and
transmitting the subsequent request to a second process.

23. The method of claim 22, wherein determining whether to broadcast a cache expiry indication comprises determining a degree of importance of the changed data item.

24. The method of claim 22, wherein determining whether to broadcast a cache expiry indication comprises determining whether current network activity is below a predefined threshold level.

25. In a system including a plurality of processes interacting with a data store, a method for propagating a cache expiry indication signifying a change to an item in the data store, the method comprising:
receiving, from a first process, an indication that at least one item in the data store has been changed by the first process;
storing a cache expiry indication identifying the changed data item; and
responsive to receiving a subsequent request:
selecting a second process to handle the subsequent request;
determining whether the second process has a need for the changed data item;
responsive to the second process having a need for the changed data item:
transmitting the stored cache expiry indication to the second process; and
transmitting the subsequent request to the second process; and
responsive to the second process not having a need for the changed data item:
transmitting the subsequent request to the second process.

26. In a system including a plurality of processes interacting with a data store, a method for propagating a cache expiry indication signifying a change to an item in the data store, the method comprising:
responsive to receiving a first request:
routing the first request to a first process;
the first process updating at least one item in the data store;
receiving, at a cache expiry manager, an indication from the first process that at least one item in the data store has been updated;
storing a cache expiry indication identifying the changed data item; and
transmitting a response to the first request; and
responsive to receiving a second request:
transmitting the stored cache expiry indication to a second process; and
routing the second request to the second process having a cache;
receiving a response to the second request from the second process; and
transmitting the received response.

27. The method of claim 26, wherein each process comprises a server and wherein each request comprises a client request.

28. The method of claim 27, wherein transmitting each response comprises transmitting the response to a user computer.

29. The method of claim 28, wherein:
routing the first client request to the first server comprises using a load balancer to route the first client request; and
routing the second client request to the second server comprises using the load balancer to route the second client request.

30. The method of claim 28, further comprising:
the second server designating its cache as expired.

31. The method of claim 28, further comprising:
the second server designating at least a portion of its cache as expired.

32. The method of claim 28, further comprising:
the second server deleting at least a portion of its cache.

33. In a system including a plurality of processes interacting with a data store, a computer program product for propagating a cache expiry indication signifying a change to an item in the data store, the computer program product comprising:
a computer-readable medium; and
computer program code, encoded on the medium, for:
receiving, from a first process, an indication that at least one item in the data store has been changed by the first process;
storing a cache expiry indication identifying the changed data item; and
responsive to receiving a subsequent request:
transmitting the stored cache expiry indication to a second process; and
transmitting the subsequent request to the second process.

34. The computer program product of claim 33, wherein each process comprises a server and wherein the request comprises a client request.

35. The computer program product of claim 34, further comprising computer program code for, prior to transmitting the stored cache expiry indication and the subsequent request to the second server, selecting a server to receive the subsequent request.

36. The computer program product of claim 35, wherein the computer program code for selecting a server to receive the subsequent request comprises computer program code for performing a load-balancing operation to select the server.

37. The computer program product of claim 34, wherein the computer program code for transmitting the subsequent request to a second server comprises computer program code for transmitting the subsequent request to a second server having a cache comprising data at least partially derived from the data store.

38. The computer program product of claim 34, wherein the stored cache expiry indication specifies the at least one data item that has changed.

39. The computer program product of claim 34, wherein the stored cache expiry indication specifies a date and time at which the source data store was changed.

40. The computer program product of claim 34, wherein the stored cache expiry indication identifies the server that caused the change to the data item.

41. The computer program product of claim 34, wherein the stored cache expiry indication identifies at least one server that has access to valid data in the cache of that server.

42. The computer program product of claim 34, further comprising computer program code for:
receiving, at the second server, the cache expiry indication; and
tagging one or more items in a cache associated with the second server as having expired.

43. The computer program product of claim 34, further comprising computer program code for:
receiving, at the second server, the cache expiry indication; and
purging one or more items from a cache associated with the second server.

44. The computer program product of claim 34, wherein the computer program code for transmitting the cache expiry indication to the second server comprises computer program code for transmitting the cache expiry indication embedded within the subsequent request.

45. The computer program product of claim 34, wherein the computer program code for transmitting the subsequent request and the cache expiry indication to the second server comprises computer program code for:
modifying the subsequent request to include the cache expiry indication; and
transmitting the modified subsequent request to the second server.

46. The computer program product of claim 34, wherein the computer program code for transmitting the cache expiry indication to the second server comprises computer program code for transmitting the cache expiry indication using an out-of-band transmission channel.

47. The computer program product of claim 34, wherein:
the computer program code for transmitting the subsequent request to the second server comprises computer program code for transmitting the subsequent request using a first transmission channel; and
the computer program code for transmitting the cache expiry indication to the second server comprises computer program code for transmitting the cache expiry indication using a second transmission channel.

48. The computer program product of claim 34, wherein the computer program code for storing the cache expiry indication comprises computer program code for:
determining whether the changed data item in the data store was referenced by a previously stored cache expiry indication; and
consolidating the cache expiry indication with the previously stored cache expiry indication.

49. The computer program product of claim 34, wherein the computer program code for transmitting the stored cache expiry indication to the second server comprises computer program code for transmitting a consolidated cache expiry indication that represents at least two cache expiry indications for the changed data item.

50. The computer program product of claim 34, wherein:
the computer program code for transmitting the subsequent client request to a second server comprises computer program code for using a load balancer to route the subsequent client request.

51. In a system including a plurality of processes interacting with a data store, a computer program product for propagating a cache expiry indication signifying a change to an item in the data store, the computer program product comprising:
a computer-readable medium; and
computer program code, encoded on the medium, for:
monitoring the data store for changes;
detecting a change in the data store;
storing a cache expiry indication identifying the changed data item; and
responsive to receiving a subsequent request, transmitting the stored cache expiry indication.

52. In a system including a plurality of processes interacting with a data store, a computer program product for propagating a cache expiry indication signifying a change to an item in the data store, the computer program product comprising:
a computer-readable medium; and
computer program code, encoded on the medium, for:
receiving, from a first process, an indication that at least one item in the data store has been changed by the first process;
storing a cache expiry indication identifying the changed data item; and
responsive to detecting a trigger event, transmitting the stored cache expiry indication to a second process;
wherein the trigger event comprises at least one selected from the group consisting of:
a subsequent request;
a determination that a predefined time period has elapsed since the cache expiry indication was stored;
a determination that a predefined number of cache expiry indications have been stored; and
a determination that a predefined amount of cache expiry indication storage has been used.

53. The computer program product of claim 52, further comprising computer program code for, responsive to the trigger event comprising a subsequent request, transmitting the subsequent request to the second process.

54. In a system including a plurality of processes interacting with a data store, a computer program product for propagating a cache expiry indication signifying a change to an item in the data store, the computer program product comprising:
a computer-readable medium; and
computer program code, encoded on the medium, for:
receiving, from a first process, an indication that at least one item in a data store has been changed by the first process;
determining whether to broadcast a cache expiry indication identifying the changed data item;
responsive to a determination that a cache expiry indication should be broadcast, broadcasting a cache expiry indication identifying the changed data item;
responsive to a determination that a cache expiry indication should not be broadcast:
storing the cache expiry indication identifying the changed data item; and
responsive to receiving a subsequent request:
transmitting the cache expiry indication to the second process; and
transmitting the subsequent request to a second process.

55. The computer program product of claim 54, wherein the computer program code for determining whether to broadcast a cache expiry indication comprises computer program code for determining a degree of importance of the changed data item.

56. The computer program product of claim 54, wherein the computer program code for determining whether to broadcast a cache expiry indication comprises computer program code for determining whether current network activity is below a predefined threshold level.

57. In a system including a plurality of processes interacting with a data store, a computer program product for propagating a cache expiry indication signifying a change to an item in the data store, the computer program product comprising:
a computer-readable medium; and
computer program code, encoded on the medium, for:
receiving, from a first process, an indication that at least one item in the data store has been changed by the first process;
storing a cache expiry indication identifying the changed data item; and
responsive to receiving a subsequent request:
selecting a second process to handle the subsequent request;
determining whether the second process has a need for the changed data item;
responsive to the second process having a need for the changed data item:
transmitting the stored cache expiry indication to the second process; and
transmitting the subsequent request to the second process; and
responsive to the second process not having a need for the changed data item:
transmitting the subsequent request to the second process.

58. In a system including a plurality of processes interacting with a data store, a computer program product for propagating a cache expiry indication signifying a change to an item in the data store, the computer program product comprising:
a computer-readable medium; and
computer program code, encoded on the medium, for:
responsive to receiving a first request:
routing the first request to a first process;
the first process updating at least one item in the data store;
receiving, at a cache expiry manager, an indication from the first process that at least one item in the data store has been updated;
storing a cache expiry indication identifying the changed data item; and
transmitting a response to the first request; and
responsive to receiving a second request:
transmitting the stored cache expiry indication to the second process; and
routing the second request to a second process having a cache;
receiving a response to the second request from the second process; and
transmitting a response to the second request.

59. The computer program product of claim 58, wherein each process comprises a server and wherein each request comprises a client request.

60. The computer program product of claim 59, wherein the computer program code for transmitting each response comprises computer program code for transmitting the response to a user computer.

61. The computer program product of claim 60, wherein:
the computer program code for routing the first client request to the first server comprises computer program code for using a load balancer to route the first client request; and
the computer program code for routing the second client request to the second server comprises computer program code for using the load balancer to route the second client request.

62. A system for propagating a cache expiry indication signifying a change to an item in a data store, the system comprising:
a data store, for storing data items used for servicing requests;
a first process, for receiving and processing requests using data items obtained from the data store;
a second process, for receiving and processing requests using data items obtained from the data store;
a first cache associated with the first process, for locally storing data items obtained from the data store;
a second cache associated with the second process, for locally storing data items obtained from the data store; and
a cache expiry manager, for:
responsive to receiving an indication that at least one item in the data store has been changed by the first process, storing a cache expiry indication identifying the changed data item; and
responsive to receiving a subsequent request, transmitting the stored cache expiry indication and the subsequent request to the second process.

63. The system of claim 62, wherein each process comprises a server and wherein the request comprises a client request.

64. The system of claim 63, further comprising a router for selecting a server to receive the subsequent request.

65. The system of claim 64, wherein the router selects a server to receive the request by performing a load-balancing operation.

66. The system of claim 63, wherein the second server receives the cache expiry indication and tags one or more data items in the second cache as having expired.

67. The system of claim 63, wherein the second server receives the cache expiry indication and purges one or more data items in the second cache.

68. The system of claim 63, wherein the stored cache expiry indication specifies at least one data item that has changed.

69. The system of claim 63, wherein the stored cache expiry indication specifies a date and time at which the source data store was changed.

70. The system of claim 63, wherein the stored cache expiry indication identifies the server that caused the change to the data item.

71. The system of claim 63, wherein the stored cache expiry indication identifies at least one server that has access to valid data in the cache of that server.

72. The system of claim 63, wherein the cache expiry manager transmits the cache expiry indication embedded within the subsequent request.

73. The system of claim 63, wherein the cache expiry manager transmits the subsequent request and the cache expiry indication to the second server by:
modifying the subsequent request to include the cache expiry indication; and
transmitting the modified subsequent request to the second server.

74. The system of claim 63, wherein the cache expiry manager transmits the cache expiry indication using an out-of-band transmission channel.

75. The system of claim 63, wherein the cache expiry manager:
transmits the subsequent request to the second server using a first transmission channel; and
transmits the cache expiry indication to the second server using a second transmission channel.

76. The system of claim 63, wherein the cache expiry manager:
determines whether the changed data item in the data store was referenced by a previously stored cache expiry indication; and
consolidates the cache expiry indication with the previously stored cache expiry indication.

77. The system of claim 63, wherein the cache expiry manager transmits a consolidated cache expiry indication that represents at least two cache expiry indications for the changed data item.

78. The system of claim 63, further comprising:
a load balancer to route the subsequent client request to the second process.

79. A system for propagating a cache expiry indication signifying a change to an item in a data store, the system comprising:
a data store, for storing data items used for servicing requests;
a process, for receiving and processing requests using data items obtained from the data store;
a cache associated with the process, for locally storing data items obtained from the data store; and
a data store monitor, for monitoring the data store for changes;
a cache expiry manager, for:
responsive to the data store monitor detecting a change to at least one item in the data store, storing a cache expiry indication identifying the changed data item; and
responsive to receiving a subsequent request from the process, transmitting the stored cache expiry indication.

80. A system for propagating a cache expiry indication signifying a change to an item in a data store, the system comprising:
a data store, for storing data items used for servicing requests;
a first process, for receiving and processing requests using data items obtained from the data store;
a second process, for receiving and processing requests using data items obtained from the data store;
a first cache associated with the first process, for locally storing data items obtained from the data store;
a second cache associated with the second process, for locally storing data items obtained from the data store; and
a cache expiry manager, for:
responsive to receiving an indication that at least one item in the data store has been changed by the first process, storing a cache expiry indication identifying the changed data item; and
responsive to detecting a trigger event, transmitting the stored cache expiry indication to a second process;
wherein the trigger event comprises at least one selected from the group consisting of:
a subsequent request;
a determination that a predefined time period has elapsed since the cache expiry indication was stored;
a determination that a predefined number of cache expiry indications have been stored; and
a determination that a predefined amount of cache expiry indication storage has been used.

81. The system of claim 80, wherein, responsive to the trigger event comprising a subsequent request, the cache expiry manager transmits the subsequent request to the second process.

82. A system for propagating a cache expiry indication signifying a change to an item in the data store, the system comprising:
a data store, for storing data items used for servicing requests;
a first process, for receiving and processing requests using data items obtained from the data store;
a second process, for receiving and processing requests using data items obtained from the data store;
a first cache associated with the first process, for locally storing data items obtained from the data store;
a second cache associated with the second process, for locally storing data items obtained from the data store; and
a cache expiry manager, for:
responsive to receiving an indication that at least one item in the data store has been changed by the first process, determining whether to broadcast a cache expiry indication identifying the changed data item;
responsive to a determination that a cache expiry indication should be broadcast, broadcasting a cache expiry indication identifying the changed data item; and
responsive to a determination that a cache expiry indication should not be broadcast:
storing the cache expiry indication identifying the changed data item; and
responsive to receiving a subsequent request, transmitting the stored cache expiry indication and the subsequent request to the second process.

83. The system of claim 82, wherein the cache expiry manager determines whether to broadcast a cache expiry indication based on a degree of importance of the changed data item.

84. The system of claim 82, wherein the cache expiry manager determines whether to broadcast a cache expiry by determining whether current network activity is below a predefined threshold level.

85. A system for propagating a cache expiry indication signifying a change to an item in the data store, the system comprising:
a data store, for storing data items used for servicing requests;
a first process, for receiving and processing requests using data items obtained from the data store;
a second process, for receiving and processing requests using data items obtained from the data store;
a first cache associated with the first process, for locally storing data items obtained from the data store;
a second cache associated with the second process, for locally storing data items obtained from the data store; and
a cache expiry manager, for:
responsive to receiving an indication that at least one item in the data store has been changed by the first process, storing a cache expiry indication identifying the changed data item; and
responsive to receiving a subsequent request:
determining whether the second process has a need for the changed data item;
responsive to the second process having a need for the changed data item:
transmitting the stored cache expiry indication and the subsequent request to the second process; and
responsive to the second process not having a need for the changed data item:
transmitting the subsequent request to the second process.

86. A system for propagating a cache expiry indication signifying a change to an item in the data store, the system comprising:
a data store, for storing data items used for servicing requests;
a router, for routing requests;
a first process, for:
receiving a first request from the router;
processing the first request using at least one data item obtained from the data store;
updating at least one item in the data store; and
transmitting an indication that at least one item in the data store has been updated;
a first cache associated with the first process, for locally storing data items obtained from the data store;
a cache expiry manager, for:
receiving the indication from the first process that at least one item in the data store has been updated;
storing a cache expiry indication identifying the changed data item; and
responsive to the router routing a second request to a second process, transmitting the stored cache expiry indication to the second process;
a second process, for:
receiving the second request and the stored cache expiry indication; and
processing the second request using at least one data item obtained from the data store; and
a second cache associated with the second process, for locally storing data items obtained from the data store.

87. The system of claim 86, wherein each process comprises a server and wherein each request comprises a client request.

88. The system of claim 87, further comprising a load balancer for selecting servers to handle requests.

89. The system of claim 86, wherein, responsive to receiving the stored cache expiry indication, the second process designates its cache as expired.

90. The system of claim 86, wherein, responsive to receiving the stored cache expiry indication, the second process designates at least a portion of its cache as expired.

91. The system of claim 86, wherein, responsive to receiving the stored cache expiry indication, the second process deletes at least a portion of its cache.
